(19) United States
(12) Patent Application Publication
(10) Pub. No.: US 2021/0311958 A1
(43) Pub. Date: Oct. 7, 2021

(54) DATA WAREHOUSING SYSTEM AND PROCESS

(71) Applicant: Make IT Work Pty Ltd, Hamilton, Queensland (AU)

(72) Inventors: Russell Searle, Eatons Hill, Queensland (AU); Andrew Hill, Melbourne, Victoria (AU)

(21) Appl. No.: 17/262,821

(22) PCT Filed: Jul. 25, 2019
(86) PCT No.: PCT/AU2019/050786

§ 371 Date: Jan. 25, 2021

(30) Foreign Application Priority Data
Jul. 25, 2018 (AU) 2018902697

(51) Int. Cl. G06F 16/25

(52) U.S. Cl. CPC G06F 16/254

(57) ABSTRACT

A data warehouse system including a plurality of input event queues that receive a plurality of data messages with message types, including one of the input event queues for each message type; a plurality of input transform operators that transform payload data in the data messages into raw data records, including one of the input transform operators and at least one of the raw data records for each message type; a raw data storage system that stores the raw data messages; a plurality of output transform operators that transform the raw data records into business or operational data records based on output rules defining output requirements; and a business data storage system that stores the business data records for generating outputs associated with the output requirements.

### RELATED APPLICATION

The present application is related to Australian Provisional Patent Application No. 2018902697 filed in the name of Make IT Work Pty Ltd on 25 Jul. 2018, the originally filed specification of which is hereby incorporated by reference in its entirety herein.

### TECHNICAL FIELD

The present disclosure relates to a system and process for data warehousing.

### BACKGROUND

Data warehouses are central repositories that store data from one or more sources. Data warehouses are often used by businesses to collate data, transform the data into a useful form (e.g., one which represents historical activities of the business for a particular period of time), and permit access to the stored data for the purpose of performing reporting and data analysis operations. The data is typically received from multiple sources, or systems, which may provide distinct types of information to the warehouse in relation to the business.

Conventional data warehousing systems perform Extract, Transform, and Load (ETL)-based operations on the data received from the one or more sources. This involves several layers of processing including the storage of the raw data from each source, the integration of disparate types or forms of data into a common form for storage into a data storage device (such as a database or similar) structure, and the transfer of the integrated data into the database of the system.

A key component of the data warehousing system is the data storage device. Databases are typically used in order to facilitate the efficient storage of vast amounts of data. When using a database, the warehoused data is stored according to a particular schema that is predetermined (designed) and built well in advance. In the context of the data warehousing system, the database has a corresponding data architecture that is designed to provide long-term historical storage of data coming in from multiple operational systems. It is desirable that the data architecture i) has a structure which reflects the key aspects of the business for analytical reporting and/or operational purposes (i.e., the outputs), ii) is resilient to changes in these key aspects (i.e., output changes), and iii) is resilient to change in the operational environment (i.e., the inputs). The design of the data architecture of the data vault is therefore an important consideration when creating a data warehouse for a business.

A data vault is a specific data warehouse design pattern that is structured according to a data vault model, e.g., Data Vault 2.0, that includes a plurality of hubs (data tables with a list of unique business keys with low propensity to change, selected to relate to business terms or outputs) connected by links (many-to-many join tables between the hub data keys), and a plurality of satellites (tables that store temporal attributes and descriptive attributes of the unique data keys.

Typically, a data vault has a data architecture (or model) that is formed based on the business keys (to form the hubs) and their associations (to form the links). This is to ensure that the data vault can model the business data irrespective of changes in the business environment (i.e., on the premise that, despite these environmental changes, the business keys remain constant). Conventional data warehousing therefore involves the design and construction of the data vault based on the assumption that the business keys are stable elements, and accordingly are a suitable foundation for the organisation of the data within the warehouse. A drawback of this approach is that the data stored by the system must conform to the pre-determined structure of the vault. If the business changes, and/or the data sources change (i.e., the inputs change due to changes in the operational systems or change in business direction) then the data architecture must be altered to enable the storage of data according to the new form.

Despite the convenience of these data warehousing technologies, there remains room for improvement. It is desired to provide data warehouse creation systems and processes that alleviate one or more difficulties of the prior art, or that at least provide a useful alternative.

### SUMMARY

Disclosed herein is a data warehouse system including:
a plurality of input event queues that receive a plurality of data messages with message types, including one of the input event queues for each message type;
a plurality of input transform operators that transform payload data in the data messages into raw data records of one or more data record types, including one of the input transform operators and at least one of the raw data records for each message type;
a raw data vault including:
   raw hubs based on static keys, and
   raw links that relate static keys between raw hubs, and
   raw satellites, associated with the raw hubs or raw links, that store the raw data records, including one of the raw satellites for each raw data record type;
a plurality of output transform operators that transform the raw data records into business or operational data records based on output rules defining output requirements; and
a business data vault including:
   business hubs based on selectable keys, and
   business links that relate these selectable keys between business hubs, and
   business satellites, associated with the business hubs or business links, that store the business data records.

There is at least one raw satellite for each message type, and each message type may contain raw data records that are written to a plurality of raw satellites, one for each raw data record type. Each input transform operator, and only that input transform operator, writes to one or more raw satellites (i.e., each raw satellite can only be written to by one of the input transform operators). Each satellite is associated with one and only one data record type.

The output transform operators can be business transform operators or operational transform operators described hereinafter.

If the output rules (or “business rules”) change, the business records can be regenerated by the output transform operators from the raw data vault without needing to go back to the original payload data in the data lake (which may have outdated message types)—so having the raw data vault makes the reporting more flexible and decoupled from the source schema.

The selectable keys are selectable by the users based on the output requirements which can change rapidly. When the output requirements change (e.g., new feedback is required, or new reporting information is required), the selectable keys can be regenerated, and the accessible business data in the business data records can be regenerated from the raw data records without having to go back to the input data messages which typically require processing by the input transform operators, which can be very slow for large data collections.

The output rules are defined by the users, and are data-processing rules that process the raw data records. The output requirements include reporting requirements (for display to the users) and operational requirements (for feedback into the operational systems, including operational systems from which the input event queues receive the data messages). The operational systems can be referred to as transactional systems. Example feedback for the operational systems might include generating a table of all customers with respective newest email addresses for updating an emailing system in the operational systems. The output transform operators can transform the raw data records according to the output rules including standardisation rules, consolidation rules (e.g., using a plurality of the raw data records), point-in-time rules, calculations (e.g., calculating a time since last purchase for each customer), record de-duplication, etc. The business satellites can include point-in-time tables, standardisation tables, and consolidation tables.

The business data vault may be referred to as a business vault or information vault. The raw data vault may be referred to as a raw vault, a data vault or a vault. The raw data vault includes raw unfiltered data from the sources, loaded into hubs, links, and satellites based on static business keys, e.g., according to the Data Vault 2.0 standards. The business data vault is an extension of a raw vault that can apply selected business rules, denormalizations, calculations, and other query assistance functions to facilitate user access, reporting to the users, and feedback to the operational systems. The business data vault tables present the data records after the application of the selected business rules, denormalizations, calculations, and other query assistance functions.

The data warehouse system may include a plurality of output event queues that deliver the data records to the output transform operators based on events in a prior data vault (which can be the raw data vault or the business data vault), including one output event queue for each data record type.

The data warehouse system may include a data lake with a plurality of data storage locations including one of the data storage locations for each message type.

The message types can be referred to as message classes. The combination of the one input event queue, the one input transform operator, the one data storage location in the data lake, the one or more raw data records, the one or more respective raw satellites, and the one or more respective output event queues, for each of the message types, can be referred to as a data stream in the data warehouse system.

Also disclosed herein is a process executed by a computing system including
generating a plurality of input event queues that receive a plurality of data messages with message types, including one of the input event queues for each message type;
generating a plurality of input transform operators that transform payload data in the data messages into raw data records of one or more data record types, including one of the input transform operators and at least one of the raw data record for each message type;
generating a raw data vault including:
   raw hubs based on static keys, and
   raw links that relate static keys between raw hubs, and
   raw satellites, associated with the raw hubs or raw links, that store the raw data records, including one of the raw satellites for each raw data record type;
generating a plurality of output transform operators that transform the raw data records into business or operational data records based on output rules defining output requirements; and
generating a business data vault including:
   business hubs based on selectable keys, and
   business links that relate these selectable keys between business hubs, and
   business satellites, associated with the business hubs or business links, that store the business data records.

Configuration of a second data vault in a typical data warehousing application would be regarded as too time-consuming to be worth it—however, when this configuration is automated, it may become advantageous.

The process may include generating a plurality of output event queues that deliver the data records to the output transform operators based on events in the prior data vault, including one output event queue for each data record type. The system need not be limited to 2 data vault (DV) layers: there may be a variable number of DV layers greater than 2.

The process may include generating a data lake with a plurality of data storage locations including one of the data storage locations for each message type.

The process may include:
receiving new output rules;
generating a plurality of new output transform operators that transform the raw data or business records into new business or operational data records based on the new output rules; and
generating a new business data vault including:
   new business hubs based on selectable keys, and
   new business links that relate these selectable keys between business hubs, and
   new business satellites, associated with the new business hubs or business links, that store the new business data records.

The new business data vault may be referred to as a “version” of the original business data vault if portions of the business data records are the same. The selectable keys may be new selectable keys or the same selectable output keys depending on user input.

Also disclosed herein is a computing system configured to execute the process.

Also disclosed herein is a data warehouse system including
(a) a plurality of input event queues that receive a plurality of data messages with message types, including one of the input event queues for each message type;
(b) a plurality of input transform operators that transform payload data in the data messages into raw data records, including one of the input transform operators and at least one of the raw data records for each message type;
(c) a raw data storage system that stores the raw data records;
(d) a plurality of output transform operators that transform the raw data records into business or operational data records based on output rules defining output requirements; and
(e) a business data storage system that stores the business data records for generating outputs associated with the output requirements.

Also disclosed herein is a process executed by a computing system including
(a) generating a plurality of input event queues that receive a plurality of data messages with message types, including one of the input event queues for each message type;
(b) generating a plurality of input transform operators that transform payload data in the data messages into raw data records, including one of the input transform operators and at least one of the raw data records for each message type;
(c) generating a raw data storage system that stores the raw data records;
(d) generating a plurality of output transform operators that transform the raw data records into business or operational data records based on output rules defining output requirements; and
(e) generating a business data storage system that stores the business data records for generating outputs associated with the output requirements.

### BRIEF DESCRIPTION OF THE DRAWINGS

Some embodiments of the present invention are hereinafter described, by way of example only, with reference to the accompanying drawings, wherein:

FIGS. 1 to 3 show a schematic diagram of a data warehousing system in accordance with some embodiments of the present invention;

FIG. 4 is a flow chart of a process in accordance with some embodiments of the present invention; and

FIG. 5 is a high-level data architecture sketch including relationships between data sources and types in the data warehousing system.

### DETAILED DESCRIPTION

Specifically, the data warehousing system presented herein receives business and technical (including a data dictionary and a schema) metadata from a user and executes a configuration process to automatically generate a data vault and a set of data streams, one per distinct message class, to allow for the servicing of simultaneous Extract, Transform, and Load (ETL) events for each data source. Each data source can have a plurality of message classes. The data vault architecture is created dynamically based on the provided metadata via an event-based compilation process. Data streams for each source are automatically generated allowing data to flow from the source to the data vault, and then through to output data marts in a highly scalable event driven architecture. Each data steam is implemented with a permanently durable ETL event queue which passes data to a vault loader module.

The system presented herein therefore provides a platform to generate both a database for storing business data, and the integration infrastructure for receiving and processing streamed data using the database simultaneously in an event driven format. This mitigates the need for technical data manipulation operations to be manually performed, while allowing for the dynamic generation of a data vault with a data architecture that is customised according to specified metadata of the business. Embodiments of the data warehouse generation system described herein may have technical advantages including:
the ability to hard compile each vault loader to only handle one type of message such that efficiency is improved (i.e., close to 0 CPU cost is achieved for ETL, irrespective of load);
the use of durable and immutable queues to enable global event sequence audits, and to enable Second level DR with the ability to completely rebuild the data vault from only input queues and the supplied metadata;
improved scalability in data processing due to the inherent parallelism for queues for data ingestion, where separate queues are utilised for each source system/message class such that, when the source(s) are configured to push messages in parallel, high throughput can be achieved via the use of scalable message queuing technology (e.g., Kafka).

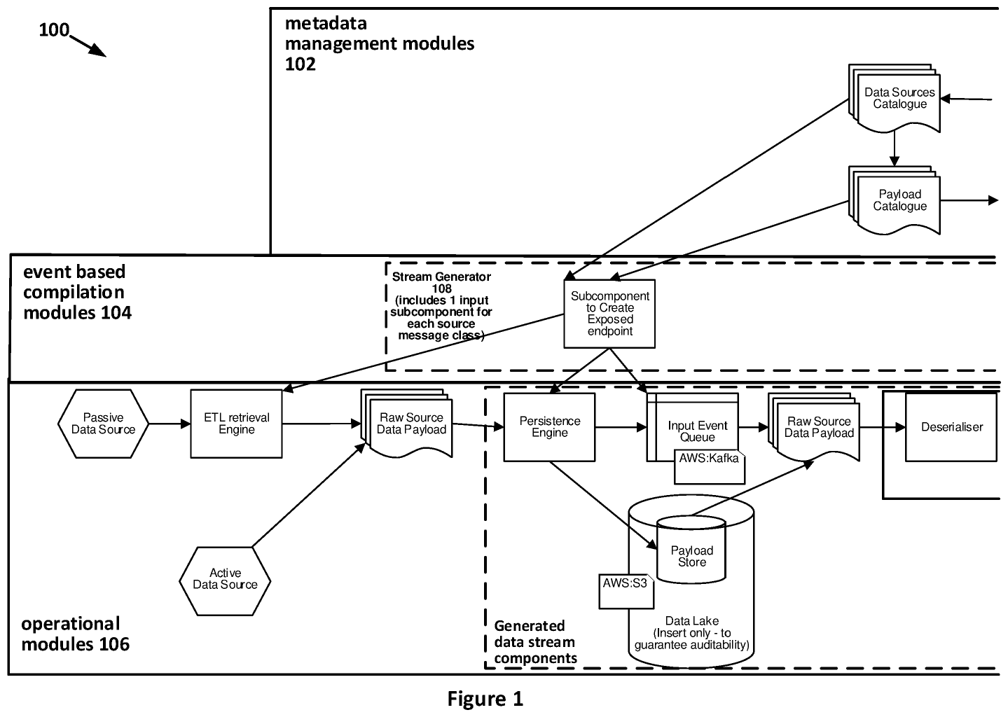

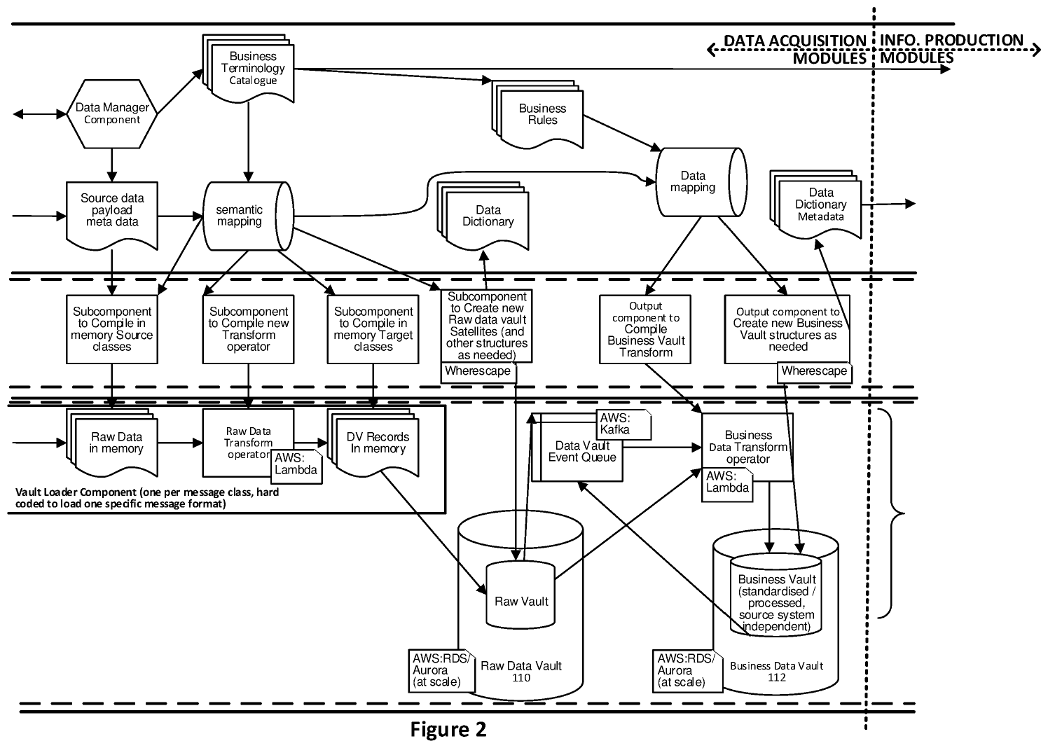

FIGS. 1 to 3 illustrate a schematic representation of a data warehouse system (DWS) 100 in accordance with some embodiments of the present invention. The DWS 100 described herein includes one or more computing devices configured to execute a data warehousing application. The data warehousing application implements a process 200 which includes a configuration phase 201 and an operation phase 203, as shown in FIG. 2. During configuration 201, business metadata is received, at step 202, and is configured as described herein to enable the generation of a data warehouse, including a data vault and a set of data streams. The generation of the data vault components occurs according to an event based compilation process, at step 204, which involves the dynamic construction of system modules which form the data warehouse. Following the event-based compilation step 204, the data warehouse acts as a customised data analytics platform for the business, where the system is capable of providing data ingestion and on-demand information production operations to a user of the system (i.e., at steps 206 and 208 respectively).

### Business Metadata Configuration

Referring to FIG. 1, in the metadata management modules 102, the business metadata received by the DWS 100 includes: a data sources catalogue; a payload catalogue; and business terminology catalogue. The data sources catalogue identifies data sources from which the system 100 can accept input data. Data sources can include, for example, computing devices and/or systems each producing data in relation to one or more aspects of the business (e.g., sales, finance or marketing). The payload catalogue specifies each type of payload (or message) that can be received by the system. For example, the system may accept ‘CustomerId’ messages relating to the identity of a customer and ‘Price change’ messages relating to a change in the sale price of a particular item.

The business terminology catalogue defines a set of terms and their relationships that are specific to the business. This can include, for example, terms that define entities associated with, or managed by, the business (such as particular products). Business terminology catalogue data and data source catalogue data are obtained based on user input.

The system 100 includes a data manager component (or “data manager”) which facilitates the generation of the data vault and the data mapping rules that will be used in the configuration of the data vault components. Inputs received by the data manager component include: i) schema and data dictionary information relating to the data sources; ii) data vault patterns; and iii) an indication of the business requirements.

In some embodiments, the data manager is configured to receive the input information from the user via a user interface component. The user interface component may provide the user with functionality allowing them to specify detailed data processing and storage structures (e.g., as usable by data engineers). In other embodiments, the ability of the user to specify input information may be limited to a selection of predetermined input values. In some embodiments, the catalogue data is generated, at least partially, based on the input information. The payload catalogue is generated at least in part by the data source catalogue, since the type of messages that are handled by the system 100 is dependent on the nature of the input data.

The data manager component is configured to generate source data payload metadata which describes the payload characteristics of each type of message that can be received by the system. Message data received from a data source includes a message type and message data, where the data includes a particular payload (as described below). The payload is within the message.

The data manager processes the business terminology catalogue and the source data payload metadata to produce a semantic mapping specific to the business, as configured by the user. The semantic mapping defines the meaning of particular terms in the context of the business. The business metadata configuration process includes the generation of business rules (or keys). This can include formulae, boundary conditions, taxonomies, etc. that can be defined based on the business terminology set. The semantic mapping and the business rules are utilised by the system 100 to perform data mapping. The data mapping process identifies a relationship between the content of a message (e.g., the terms used within the message) and the source message type such that a previously undefined, or unknown, message is resolved correctly according to the business context (i.e., in accordance with the currently identified business keys).

### Event Based Compilation and Data Vault (DV) Modelling

During the business metadata configuration process, the system functions to generate metadata that can be used to construct an appropriate data vault model for the business (as described in the event based compilation and data ingestion steps below). Specifically, in the described embodiments the data vault model includes at least two distinct data vault types: i) a raw data vault 110 which holds raw data that is transformed from received payload data; and ii) a business data vault 112 which holds business data that is transformed from the raw data (i.e., the data of the raw data vault).

In each of the raw and business data vaults (DVs), hubs are defined based on the business keys determined during the metadata configuration step (i.e., step 202 as described above). The business DV keys are referred to herein as “selectable keys” or “selected business keys”, since the keys are dynamically chosen by the system based on data design and business context information provided during the configuration process. Each of the raw and business data vaults includes DV links that relate their respective keys to their respective hubs, and satellites, associated with their respective hubs, where the satellites store the raw data records and business data records respectively.

The system 100 receives, from each of an arbitrary number N of data sources (including passive data sources and active data sources), message data, where the message data includes an indication of a message type, and payload data. The generation of raw data from payload data is performed by the use of a raw data transform operator, where the operator is specific to the message type. The generation of business data from the raw data is performed by the use of a business data transform operator. The business data transform operator is based on the business rules defined during the business metadata configuration process described above.

During the event-based compilation process 204, the DWS 100 generates the data vault and data stream components of the warehouse (i.e., the data vaults as described above) according to the business context (i.e., the selected keys). Compilation involves the configuration of one or more data vaults to allow for the servicing of simultaneous ETL events for each data source.

During the event-based compilation process of step 204, the compilation modules 104 (or “configuration components”) of the system 100 generate a set of data streams by invoking a stream generation component 108 (or “stream generator”) which includes a plurality of subcomponents as shown in FIGS. 1 and 2. The stream generation component incudes 1 input subcomponent (named “subcomponents” in Figures and 2) for each source message class. The stream generation component receives the business metadata configuration data, as generated at step 202, as input. With reference to FIG. 1, stream generation involves the creation of an exposed endpoint based on data source catalogue and payload catalogue data. For each source message type, the stream generator requests the creation and subsequent initialisation of a message queue to receive messages of this type (i.e., from the particular data source). For example, for a system 100 receiving data from 3 data sources and with 10 possible message types being received per data source, the stream generator is invoked to create 3×10=30 message queues in total. This allows messages of each difference type to be processed separately for each data source, thus improving the efficiency and scalability of the system compared to implementations with a single, or shared, message queues for each data source. The event queue data generated by the stream generator component is utilised by the operational modules 106 of the system 100, including an ETL retrieval engine, a persistence engine and an event queue engine during the operation of the data warehouse, as described below at step 206.

Event-based compilation involves performing compilation operations to output requests to create system modules related to the operation of the raw data vault, including: memory source classes; new transform operators (i.e., raw data transform operators); memory target classes; raw data vault satellites; and any other structures as needed. Compilation also involves the generation of requests to create system modules related to the operation of the business data vault, including: new transform operators (i.e., business data transform operators); and new business vault structures. The above described compilation operations are replicated to generate raw data transform and business data transform operations for each for each source message type (or “class”).

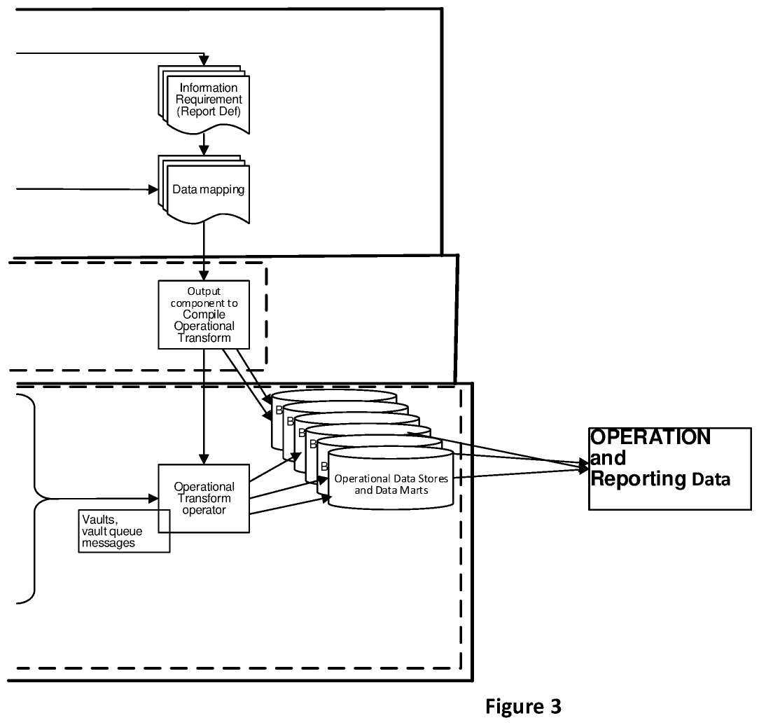

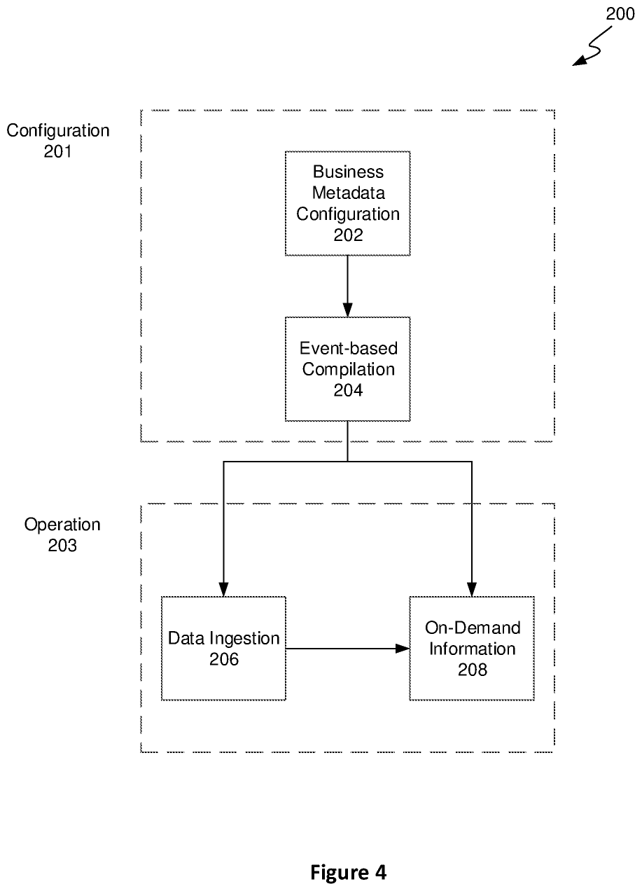

As shown in FIGS. 2 and 3, the compilation modules 104 includes the stream generator 108 which includes three output components to (1) compile the business vault transform operator, (2) create the new business vault structures as needed (e.g., using Wherescape), and (3) to compile the operational transform operator.

These output components effectively apply the business rules after the primary data vault such that the operational modules 106 that are downstream of the raw data vault 110 can be recreated or updated when business rules change.

The compilation process 204 results in the creation of memory entries or locations for specific module data. In the described embodiments, this includes data representing strongly typed classes for each message class of the data sources. These classes are appropriately annotated for object-relational mapping (ORM). These classes are type safe, and are flagged for appropriate Json/XML deserialsation. Memory entries are also created for strongly typed classes representing each destination data vault entity (i.e., Hubs, Satellites, or Links). These entities may be mapped to a destination table to improve the efficiency of access.

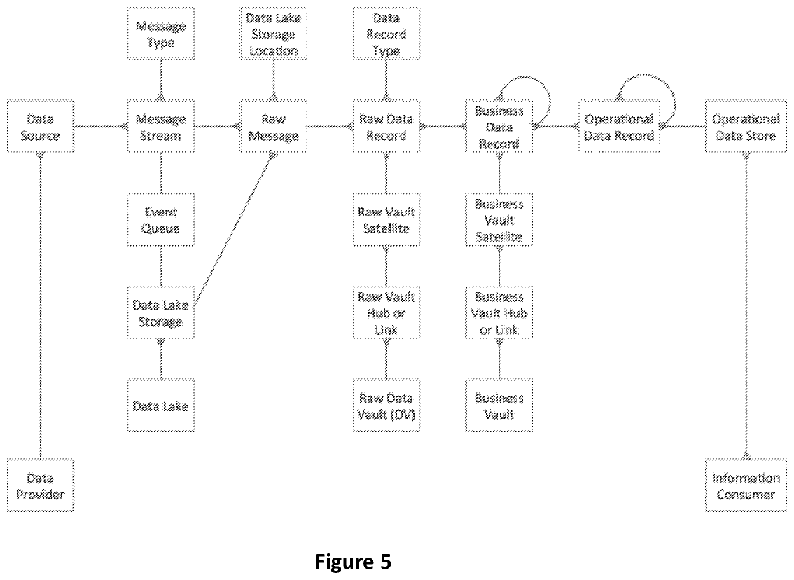

With reference to FIG. 5, there is at least one raw satellite for each message type, and each message type may contain a plurality of raw data records that are written to a corresponding plurality of raw satellites, i.e., one raw satellite for each raw data record type. Each input transform operator, and only that input transform operator, writes to one or more raw satellites (i.e., each raw satellite can only be written to by one of the input transform operators). Each satellite is associated with one and only one data record type.

The compilation process results in the generation of operational modules 106 that enable data warehousing according to the generated data vault model. Specifically, the requests to create system modules and memory spaces are processed prior to the operation of the system to create a vault loader component, as described herein below. The compilation process also results in the generation of a convert function which takes a specific source message class as input and returns a list of data vault entities for import. Modules which perform runtime linking (referred to as a “runtime linker”) for each class are generated as a result of the compilation process. Each runtime linker can perform the following functions: receive/retrieve objects of a specific message class; de-serialize the objects as necessary, detecting that input is xml/json; for each in-memory object, call the convert function to output a list of database typed objects; and write the typed objects to the database (i.e., to the appropriate data vault).

In the described embodiments, generation of the raw data vault and business data vault structures includes the production of data dictionary metadata. The data dictionary metadata is utilised by the system during information reporting and analysis operations, such as for example during requirement reporting activities

### Operation—Event-Based Data Ingestion and On-Demand Information

At step 206, the data warehouse defined by the modules generated during the event-based compilation process 204 is operated to ingest data received by the data sources. Each of the data sources can be an active data source or a passive data source. Data messages received from a passive data source are processed directly by the ETL retrieval engine, which generates raw source data payload information. This process can involve extracting the payload field from the message data following the receipt of the message according to a particular communications protocol (e.g., an Internet Protocol when communication occurs over a wide area network).

The raw source payload data is fed to a data connector in the form of the persistence engine (e.g., a Web API) which operates to store the payload data in a data storage structure for lossless retrieval by the input event queues. In the described embodiments, the payload data is stored in a data lake in a read-only format in order to ensure authenticity and auditability. The persistence engine passes the payload data to the input event queue of the appropriate message type. Each input event queue may be implemented as a durable and immutable queue according to Kafka. This may enable global event queue sequence audits, and the ability to rebuild the raw data vault from only the contents of the queue and the metadata dictionary. As the persistence engine was generated from the metadata, it includes an exposed technical endpoint (created during the event-based compilation process 204) for each message. The persistence engine is a form of “front door” to the system 100. The persistence engine assures that the data received is recorded reliably in the data lake, and that the messages are recorded in the input event queues. The data lake and input event queues can thus retain all data from the input steams. Thus there is no need to go back to the original data sources to access the received messages (in the order they were received) if the data vaults need to be rebuilt and repopulated: all messages, including their payloads and delivery metadata, are stored in the data lake and input event queues. As shown in FIG. 5, for each message stream is generated a corresponding event queue and a corresponding data lake storage location.

The event queue data and the stored payload data are accessed by an Event Queue Follower module, which reads the data and passes it to the correct transformer (via the vault loader, as described below) in order to populate the raw data vault. The Event Queue Follower includes a data storage module and a deserialiser module shown in FIG. 1.

The DWS 100 includes a vault loader component that is dynamically generated based on the module creation requests output from the event-based compilation step 206. As shown in FIGS. 1 and 2, in addition to the deserialiser, the vault loader component includes structures for storing data records in memory, and the raw data transform operators. The vault loader component may include the raw data vault, the business data transform operators, and the business data vault. The deserialised payload data produced by the Event Queue Follower from received data messages is passed to the vault loader. The vault loader stores the received data in memory and applies the appropriate transformation operator to transform the (payload) data into at least one raw data record. Distinct transformation operators are used for each message type in the described embodiments, as discussed above. The generated raw data records are stored in the corresponding memory structures. The vault loader stores the generated raw data records in the raw data vault according to the architecture (i.e., satellites, hubs and links) determined during the compilation step. In the described embodiments, the raw data vault data architecture includes one satellite per raw data record type (including historical message class versions). The raw data vault is configured in an ‘insert-only’ mode such that raw data records can be stored, but no transformation or aggregation of the stored data can occur.

The vault loader processes raw data records using a Data Vault Event Queue component to generate business data records for storage in the business data vault. The Data Vault Event Queue is implemented in Kafka as a durable and immutable queue similarly to the Event Queue which receives payload data (as described above). The raw data records within the Data Vault Event Queue are processed to generate business data records using a business data transform operator appropriate to the particular message type to which the record corresponds. The vault loader stores the generated business data records in the business data vault according to the architecture (i.e., satellites, hubs and links) determined during the compilation step. In the described embodiments, the business data vault data architecture includes standardised entries and attributes, as determined based on the business rules. The storage protocol is configured to allow for data loss in the described embodiments in order to improve efficiency.

The vault loader is configured according to a dual data vault setup, in which the contents of the first data vault (i.e., the raw data vault) is used to automatically generate contents of the second data vault (i.e., the business data vault). As a result, if the business rules change (i.e., during the business metadata configuration step), the business records can be regenerated by the output transform operators from the raw data vault without requiring the original payload data in the payload store (which may have outdated message types). This allows the DWS 100 to provide data analysis and reporting operations that are more flexible and decoupled from the source schema (since the business records are dynamically generated from the raw data vault). Typically, multiple data vaults are not used in data warehousing systems due to the time-consuming nature of configuring each vault (which conventionally requires manual input from a user of the system). However, when this configuration is automated, as described herein, the advantages of increased flexibility and scalability can be realised without impacting configurability.

The raw data vault 110 includes standardised entities, i.e., 1 satellite per source message type for each affected hub (including historical message class versions), has no transformation or aggregation, is insert only, and is immutable.

In an example, the vault loader component utilises the Lambda (AWS) serverless compute service to perform data transformation operations. The raw data vault and business data vault components are implemented using the Aurora Relational Database Service (RDS).

At step 208, the DWS 100 provides on-demand information to a user of the system via the generation of one or more operational data marts. Business data records from the business data vault, as generated during the ingestion step 206, are transformed via an operational transform operator. The operational transform operator is generated as a result of an operational transform compilation process, as performed during event-based compilation (i.e., at step 204). The operational transform operator is generated based on a set of operations that are desired to be performed on the business data. These operations are specified based on the data mapping as produced during the business metadata configuration process (i.e., at step 202). The generated operational data marts present the desired data according to the specified pattern (or map), where each mart can be configured to provide data oriented to a specific line or aspect of the business. The specialised data presented in each mart can then be utilised by a user or analyst for analysis and/or reporting.

In the operational transform operator, the business rules are applied, entities are standardised, attributes are standardised, data loss is acceptable. point-in-time tables can be generated, and calculations for operational concerns can be made. The operational transform operator can be rebuilt “on demand” when the business rules are changed.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A data warehouse system including
(a) a plurality of input event queues that receive a plurality of data messages with message types, including one of the input event queues for each message type;
(b) a plurality of input transform operators that transform payload data in the data messages into raw data records of one or more data record types, including one of the input transform operators and at least one of the raw data records for each message type;
(c) a raw data vault including:
(i) raw hubs based on static keys, and
(ii) raw links that relate static keys between raw hubs, and
(iii) raw satellites, associated with the raw hubs or raw links, that store the raw data records, including one of the raw satellites for each raw data record type;
(d) a plurality of output transform operators that transform the raw data records into business or operational data records based on output rules defining output requirements; and
(e) a business data vault including:
(i) business hubs based on selectable keys, and
(ii) business links that relate these selectable keys between business hubs, and
(iii) business satellites, associated with the business hubs or business links, that store the business data records.

2. The data warehouse system of claim 1, including a plurality of output event queues that deliver the data records to the output transform operators based on events in the prior data vault, including one output event queue for each raw data record type.

3. The data warehouse system of claim 1 or 2, including a data lake with a plurality of data storage locations including one of the data storage locations for each message type.

4. A process executed by a computing system including
(a) generating a plurality of input event queues that receive a plurality of data messages with message types, including one of the input event queues for each message type;
(b) generating a plurality of input transform operators that transform payload data in the data messages into raw data records, including one of the input transform operators and at least one of the raw data record for each message type;
(c) generating a raw data vault including:
(i) raw hubs based on static keys, and
(ii) raw links that relate static keys between raw hubs, and
(iii) raw satellites, associated with the raw hubs or raw links, that store the raw data records, including one of the raw satellites for each raw data record type;
(d) generating a plurality of output transform operators that transform the raw data records into business or operational data records based on output rules defining output requirements; and
(e) generating a business data vault including:
(i) business hubs based on selectable keys, and
(ii) business links that relate these selectable keys between business hubs, and
(iii) business satellites, associated with the business hubs or business links, that store the business data records.

5. The process of claim 4, including generating a plurality of output event queues that deliver the data records to the output transform operators based on events in the prior data vault, including one output event queue for each raw data record.

6. The process of claim 4 or 5, including generating a data lake with a plurality of data storage locations including one of the data storage locations for each message type.

7. The process of any one of claims 4 to 6, including
(a) receiving new output rules;
(b) generating a plurality of new output transform operators that transform the raw data records into new business or operational data records based on the new output rules; and
(e) generating a new business data vault including:
(i) new business hubs based on selectable keys, and
(ii) new business links that relate these selectable keys between business hubs, and
(iii) new business satellites, associated with the new business hubs or business links, that store the new business data records.

8. A computing system configured to execute the process of any one of claims 4 to 7.

9. A data warehouse system including
(a) a plurality of input event queues that receive a plurality of data messages with message types, including one of the input event queues for each message type;
(b) a plurality of input transform operators that transform payload data in the data messages into raw data records, including one of the input transform operators and at least one of the raw data records for each message type;
(c) a raw data storage system that stores the raw data messages;
(d) a plurality of output transform operators that transform the raw data records into business or operational data records based on output rules defining output requirements; and
(e) a business data storage system that stores the business data records for generating outputs associated with the output requirements.

10. A process executed by a computing system including
(a) generating a plurality of input event queues that receive a plurality of data messages with message types, including one of the input event queues for each message type;
(b) generating a plurality of input transform operators that transform payload data in the data messages into raw data records, including one of the input transform operators and at least one of the raw data records for each message type;
(c) generating a raw data storage system that stores the raw data records;
(d) generating a plurality of output transform operators that transform the raw data records into business or operational data records based on output rules defining output requirements; and
(e) generating a business data storage system that stores the business data records for generating outputs associated with the output requirements.

11. A computing system configured to execute the process of claim 10.
